(19) United States
(12) Patent Application Publication
(10) Pub. No.: US 2026/0343471 A1
(43) Pub. Date: Oct. 29, 2026

(54) METHOD FOR INDICATING LOCATION, TERMINAL, ACCESS NETWORK DEVICE, CORE NETWORK DEVICE, AND STORAGE MEDIUM

(71) Applicant: BEIJING XIAOMI MOBILE SOFTWARE CO., LTD., Beijing (CN)

(72) Inventor: Xiaolong LI, Beijing (CN)

(21) Appl. No.: 19/115,204

(22) PCT Filed: Sep. 29, 2022
(86) PCT No.: PCT/CN2022/122858

§ 371 Date: Mar. 25, 2025

(51) Int. Cl. H04W 64/00

(52) U.S. Cl. CPC H04W 64/00

(57) ABSTRACT

A method for indicating a location, including: a terminal receives first position information sent by a core network device, where the first position information is configured for positioning the terminal and includes at least one of ephemeris information, indication information or second location information of an access network device; the second position information is location information of the access network device at different moments; and the indication information is instructingconfigured to indicate the terminal to determine a location of the access network device based on the ephemeris information or the second position information.

### CROSS-REFERENCE TO RELATED APPLICATIONS

The present application is a U.S. National Stage of International Application No. PCT/CN2022/122858, filed on Sep. 29, 2022, the contents of all of which are incorporated herein by reference in their entireties for all purposes.

### BACKGROUND OF THE INVENTION

In a mobile communication system, a plurality of positioning technologies are provided and introduced. A location of a terminal is determined by the introduced positioning technologies.

### SUMMARY OF THE INVENTION

The present disclosure relates to the field of mobile communications, in particular to a method and device for indicating a location, a device, and a storage medium.

An embodiment of the present disclosure provides a method and device for indicating a location, a device, and a storage medium.

According to a first aspect of the present disclosure, a method for indicating a location is provided. The method is performed by the terminal and includes:
receiving first location information sent by a core network device, where the first location information is configured for positioning the terminal and includes at least one of ephemeris information, indication information, or second location information of an access network device; the second location information is location information of the access network device at different moments; and the indication information is configured to indicate the terminal to determine a location of the access network device based on the ephemeris information or the second location information.

According to a second aspect of the present disclosure, a method for indicating the location is provided. The method is performed by the core network device and includes:
receiving first location information sent by an access network device, where the first location information includes at least one of ephemeris information, indication information, or second location information of the access network device; the second location information is location information of the access network device at different moments; and the indication information is configured to indicate a terminal to determine a location of the access network device based on the ephemeris information or the second location information.

According to a third aspect of the present disclosure, a method for indicating the location is provided. The method is performed by the access network device and includes:
sending first location information to a core network device, where the first location information includes at least one of ephemeris information, indication information, or second location information of the access network device; the second location information is location information of the access network device at different moments; and the indication information is configured to indicate a terminal to determine a location of the access network device based on the ephemeris information or the second location information.

According to a fourth aspect of the present disclosure, a terminal is provided, where the terminal includes: one or more processors; and a transceiver connected to the one or more processors; where the one or more processors are configured to load and execute the executable instructions to collectively perform the method for indicating the location in the above first aspect.

According to a fifth aspect of the present disclosure, a core network device is provided, where the core network includes: one or more processors; and a transceiver connected to the one or more processors; where the one or more processors are configured to load and execute executable instructions to collectively perform the method for indicating the location according to in the above second aspect.

According to a sixth aspect of the present disclosure, an access network device is provided, where the access network device includes: one or more processors; and a transceiver connected to the one or more processors; where the one or more processors are configured to load and execute the executable instructions to collectively perform the method for indicating the location in the above third aspect.

According to a seventh aspect of the present disclosure, a non-transitory computer-readable storage medium storing executable program codes is provided, where the executable program codes, when loaded and executed by a processor, implement the method for indicating the location in the above first aspect.

### BRIEF DESCRIPTION OF DRAWINGS

In order to illustrate the technical solutions in the embodiments of the present disclosure more clearly, the accompanying drawings required to be used in the description of the embodiments will be briefly introduced below. Obviously, the accompanying drawings in the following description are only some embodiments of the present disclosure, and for those of ordinary skill in the art, other drawings can also be obtained according to these drawings without paying inventive step.

FIG. 1 shows a block diagram of a communication system according to an example of the present disclosure;

FIG. 2 shows a block diagram of another communication system according to an example of the present disclosure;

FIG. 3 shows a block diagram of another communication system according to an example of the present disclosure;

FIG. 4 shows a flowchart of a method for indicating a location according to an example of the present disclosure;

FIG. 5 shows a flowchart of a method for indicating the location according to an example of the present disclosure;

FIG. 6 shows a flowchart of a method for indicating the location according to an example of the present disclosure;

FIG. 7 shows a block diagram of a device for indicating the location according to an example of the present disclosure;

FIG. 8 shows a block diagram of another device for indicating the location according to an example of the present disclosure;

FIG. 9 shows a block diagram of a device for indicating the location according to an example of the present disclosure;

FIG. 10 shows a block diagram of another device for indicating the location according to an example of the present disclosure;

FIG. 11 shows a block diagram of a device for indicating the location according to an example of the present disclosure;

FIG. 12 shows a block diagram of another device for indicating the location according to an example of the present disclosure; and

FIG. 13 shows a schematic structural diagram of a communication device according to an example of the present disclosure.

### DETAILED DESCRIPTION OF THE INVENTION

In order to make the objects, technical solutions and advantages of the present disclosure clearer, the embodiments of the present disclosure will be further described in detail below with reference to the accompanying drawings.

Examples will be described in detail here, instances of which are shown in accompanying drawings. When the following description relates to the drawings, the same numbers in different drawings represent the same or similar elements unless otherwise indicated. The embodiments described in the following examples do not represent all embodiments consistent with the present disclosure. Rather, they are merely examples of devices and methods consistent with some aspects of the present disclosure as detailed in the appended claims.

The terms used in the present disclosure are for the purpose of describing particular embodiments only and are not intended to limit the present disclosure. As used in the present disclosure and the appended claims, the singular forms “a”, “said”, and “the” are intended to include the plural forms as well, unless the context clearly indicates otherwise. It should also be understood that the term “and/or” used herein refers to and includes any or all possible combinations of one or more associated listed items.

It should be understood that although the terms such as first, second, and third may be employed in the present disclosure to describe various information, such information should not be limited to these terms. These terms are only used to distinguish the same type of information from one another. For example, first information may also be referred to as second information, and similarly, second information may also be referred to as first information, without departing from the scope of the present disclosure. The word “if” used here may be interpreted as “at the time of” or “when” or “in response to determining,” for example, depending on the context.

It should be noted that information (including but not limited to user device information, user personal information, etc.), data (including but not limited to analyzed data, stored data, displayed data, etc.) and signals involved in the present disclosure are all authorized by users or fully authorized by all parties, and the collection, use and processing of relevant data need to comply with relevant laws and regulations and standards of relevant countries and regions.

In a mobile communication system, a plurality of positioning technologies are provided and introduced. A location of a terminal is determined by the introduced positioning technologies. Specifically, an access network device may report its own fixed location information to a location management function (LMF) network element. In this way, the LMF network element or the terminal determines the location of the terminal based on the location information of the access network device. However, at present, since a location of the access network device may be changed, there is an urgent need for a new solution for positioning the terminal based on a changed location.

The application scenarios of the present disclosure are described below.

Referring to FIG. 1, FIG. 1 shows a block diagram of a communication system according to an example of the present disclosure. A communication system 100 may include a terminal device 10 and a network device, where the network device may include at least one of an access network device 20 or a core network device 30.

The terminal device 10 may refer to a user equipment (UE), an access terminal, a subscriber unit, a subscriber station, a mobile station, a mobile station (MS), a remote station, a remote terminal, a mobile device, a wireless communication device, a user agent, or a user device. Alternatively, the terminal device 10 may also be a cellular phone, a cordless phone, a session initiation protocol (SIP) phone, a wireless local loop (WLL) station, a personal digital assistant (PDA), a handheld device having a wireless communication function, a computing device or other processing device connected to a wireless modem, a vehicle-mounted device, a wearable device, a terminal device in a 5^{th} generation system (5GS) or a terminal device in a future evolved public land mobile network (PLMN), which is not limited in the embodiments of the present disclosure. For convenience of description, the above devices are collectively referred to as terminal devices. A plurality of the terminal devices 10 are typically provided, and one or more terminal devices 10 may be distributed within a cell managed by each access network device 20.

The access network device 20 is a device deployed in an access network to provide a wireless communication function for the terminal device 10. The access network device 20 may include various forms of macro base stations, micro base stations, relay stations, access points, and the like. In a system employing different radio access technologies, the names of devices with the access network device function may change, e.g., the device is referred to as gNodeB or gNB in a 5G new radio (NR) system. As communication technologies evolve, the name “access network device” may change. For convenience of description, in the embodiments of the present disclosure, the device for providing the wireless communication function for the terminal devices 10 is collectively referred to as the access network device. Alternatively, a communication relationship may be established between the terminal device 10 and the core network device 21 via the access network device 20. For example, in a long term evolution (LTE) system, the access network device 20 may be an evolved universal terrestrial radio access network (EUTRAN) or one or more eNodeBs in the EUTRAN; and in the 5G NR system, the access network device 20 may be a radio access network (RAN) or one or more gNBs in the RAN.

For example, each access network device 20 includes one or more transmission reference points (TRPs). Each TRP may be referred to as a positioning node. The terminal device 10 receives a downlink positioning signal transmitted by a positioning node, and measures and reports the downlink positioning signal.

The core network device 21 is a device deployed in a core network. The main functions of the core network device 21 are to provide a user connection, manage a user, establish a bearer for a service, and provide an interface to an external network as a bearer network. For example, the core network device in the 5G NR system may include an access and mobility management function (AMF) network element, a user plane function (UPF) network element, a session management function (SMF) network element, and the like.

For example, the core network device 21 in the embodiment of the present disclosure may include a location management function network element. Alternatively, the location management function network element includes a location server, and the location server may be implemented as any one of: the LMF, an enhanced serving mobile location centre) (E-SMLC), a secure user plane location (SUPL), and a SUPL location platform (SUPL SLP).

In one example, the access network device 20 and the core network device 21 communicate with each other via a certain air interface technology, such as an NG interface in the 5G NR system. The access network devices 20 and the terminal devices 10 communicate with each other via a certain air interface technology, such as a Uu interface.

The “5G NR system” in the embodiment of the present disclosure may also be referred to as a 5G system or an NR system, but its meaning may be understood by those skilled in the art. The technical solution described in the embodiment of the present disclosure may be applicable to the 5G NR system or a subsequent evolved system of the 5G NR system.

The technical solution in the embodiment of the present disclosure may be applied to various communication systems, for example: a global system of mobile communication (GSM), a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of the NR system, an LTE-based access to unlicensed spectrum (LTE-U) system, an NR-U system, a universal mobile telecommunication system (UMTS), a worldwide interoperability for microwave access (WiMAX) communication system, a wireless local area network (WLAN), wireless fidelity (WiFi), a next-generation communication system, or other communication system, or the like.

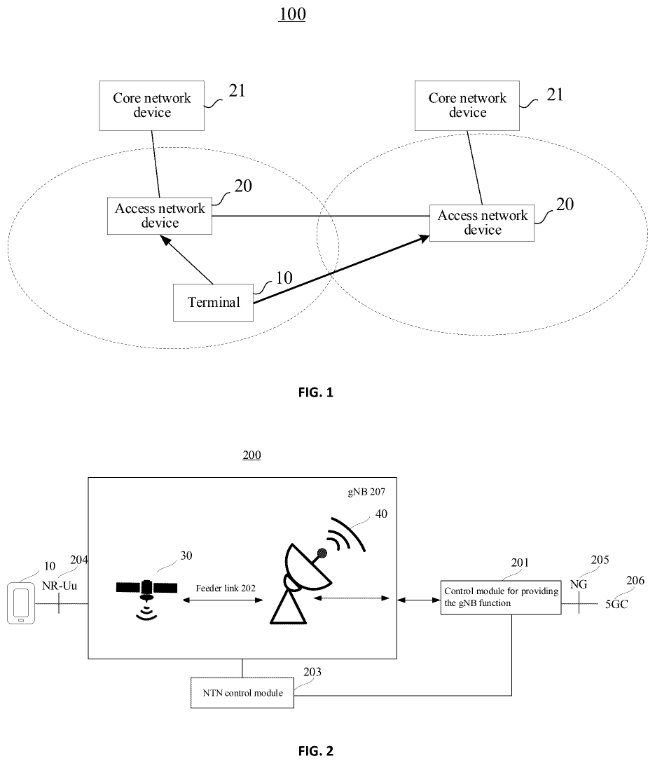

In some embodiments, the communication system 100 shown in FIG. 1 is applied to a non-terrestrial network (NTN) architecture, e.g., as shown in FIG. 2, the NTN architecture 200 includes a terminal device 10, a transfer device 30, and a ground station 40.

The transfer device 30 and the ground station 40 can be understood as the access network device 20 in the above embodiment. The access network device 20, which consist of the transfer device 30 and the ground station 40, may be referred to as gNB 207. The access network device 20 includes a control module 201 for providing the gNB function, and the transfer device 30 and the ground station 40 communicate with each other via a feeder link 202, constituting a NTN service link distribution system. And the transfer device 30 and the ground station 40 are controlled by an NTN control module 203. The NTN control module 203 connected to the control module 201 for providing the gNB function. The terminal device 10 communicates with the transfer device 30 via NR-Uu 204 (a communication interface), and the control module 201 for providing the gNB function communicates with a 5G core network (5GC) 206 via NG 205 (a communication interface).

In the embodiment of the present disclosure, if a signal needs to be sent to the terminal device 10, the signal is first sent to the transfer device 30 and the ground station 40, and the transfer device 30 and the ground station 40 then forward the received signal to the terminal device 10.

Alternatively, the transfer device 30 may be a satellite, an unmanned aerial vehicle, or other device having a transfer function, which is not limited in the embodiments of the present disclosure.

In some embodiments, a plurality of the transfer devices 30 may be provided, and each transfer device 30 manages at least one cell. The transfer device 30 needs to configure a parameter configuration of each cell for the terminal, and please refer to the following embodiment for details.

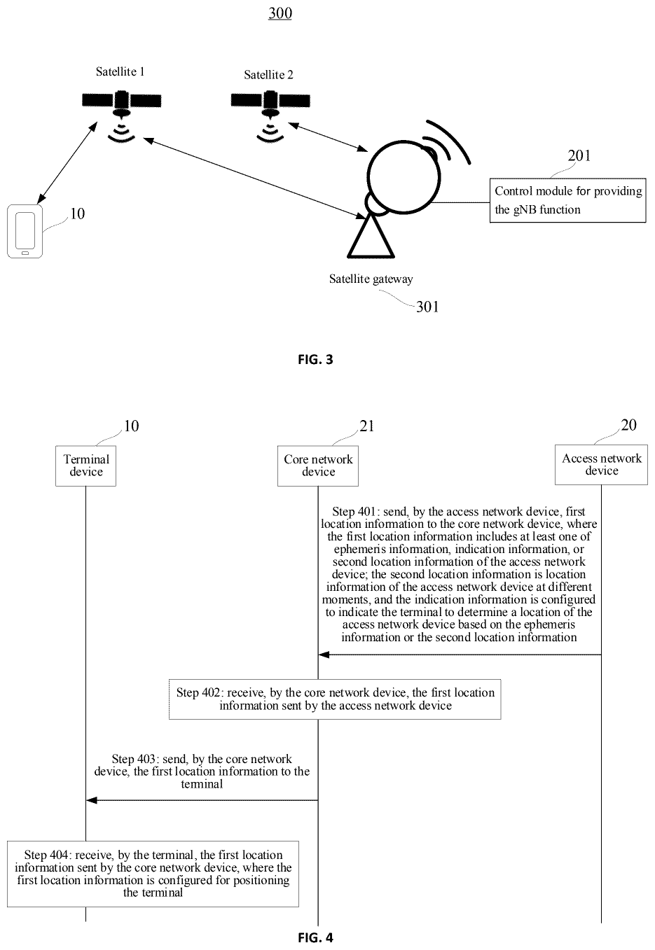

For example, the transfer device 30 is a satellite. The NTN architecture 300 in an embodiment shown in FIG. 3, a satellite 1 and a satellite 2 are connected to the control module 201 for providing the gNB function via a satellite gateway 301. That is, the satellite 1 and the satellite 2 use the same parameter configuration to configure cells for the terminal device 10. Thus, the same parameter configuration can be used in the cells managed by the satellite 1 and the satellite 2.

Or, in addition to that shown in FIG. 3, the satellite 1 and the satellite 2 are connected to the control module 201 for providing the gNB function via two satellite gateways 301, respectively, that is, the satellite 1 and the satellite 2 use different parameter configurations.

It should be noted that the NTN architecture shown in FIG. 2 or FIG. 3 is only an example, and the present disclosure is not limited to the network architecture shown in FIG. 2 or FIG. 3, and other types of network architectures are also applicable.

FIG. 4 shows a flowchart of a method for indicating a location according to an example of the present disclosure, and the method for indicating the location may, for example, be applied to the terminal device 10 and the core network device 21 as shown in FIG. 1, the method including at least some of the following contents.

Step 401: first location information is sent to the core network device by the access network device, where the first location information includes at least one of ephemeris information, indication information, or second location information of the access network device; the second location information is location information of the access network device at different moments; and the indication information is configured to indicate the terminal to determine a location of the access network device based on the ephemeris information or the second location information.

Step 402: the first location information sent by the access network device is received by the core network device.

Step 403: the first location information is sent to the terminal by the core network device.

Step 404: the first location information sent by the core network device is received by the terminal, where the first location information is configured for positioning the terminal.

The ephemeris information of the access network device is configured to indicate the location of the access network device. In some embodiments, the access network device is applied to an NTN system, the access network device includes the satellite, and actually, the ephemeris information of the access network device is ephemeris information of the satellite.

In some embodiments, the access network device includes the satellite, and the ephemeris information includes at least one of: orbit information of the satellite, or position velocity time (PVT) information of the satellite. The orbit information of the satellite indicates an orbit occupied by the satellite during operation, so the location of the satellite can be determined via the orbit information. The PVT information of the satellite indicates a location, velocity and time of the satellite during operation, and the location of the satellite can also be determined based on the PVT information.

The indication information indicates the terminal to determine the location of the access network device based on the ephemeris information or the second location information. In some embodiments, if the first location information includes the ephemeris information of the access network device, the terminal may determine, based on the indication information, that the location of the access network device may be determined based on the ephemeris information of the access network device. Or, the terminal may also obtain the ephemeris information of the access network device in other ways, e.g., by receiving ephemeris information broadcast by the access network device. The terminal determines the location of the access network device by using the ephemeris information, based on the indication information.

In other embodiments, if the first location information includes the second location information of the access network device, the terminal may determine, based on the indication information, that the location of the access network device may be determined based on the second position information of the access network device. Or, the terminal may also obtain the second location information of the access network device in other ways, e.g., by the second position information broadcast by the access network device. The terminal determines the location of the access network device by using the second location information, based on the indication information.

The state of the access network device may be a state of motion, so the access network device may be at different locations at different moments, and second location information for indicating its own locations at different moments is sent by the access network device, and the locations at different moments can be determined by the terminal based on the second location information.

It should be noted that the second location information in the embodiment of the present disclosure may indicate a plurality of locations, that is, a plurality of the second location information may be provided.

In addition, the first location information may include any one of:
(1) The ephemeris information of the access network device.
(2) The indication information.
(3) The second location information.
(4) The ephemeris information and the indication information of the access network device.
(5) The ephemeris information and the second position information of the access network device.
(6) The ephemeris information, the indication information and the second position information of the access network device.

In the embodiments of the present disclosure, the first location information is sent to the core network device by the access network device, the received first location information is sent to the terminal by the core network device. After the first location information sent by the core network device is received by the terminal, the location of the access network device can be determined based on the first location information, and the terminal is then positioned based on the location of the access network device to determine the location of the terminal.

In some embodiments, the core network device is the LMF network element, or other network element, which is not limited in the embodiments of the present disclosure.

It should be noted that the first location information sent by the access network device to the core network device, and the first location information sent by the core network device to the terminal are included in the embodiments of the present disclosure. In some embodiments, the first location information sent by the access network device to the core network device includes the same content as the first location information sent by the core network device to the terminal. In some embodiments, the first location information sent by a first access network device to the core network device is different from the first location information sent by the core network device to the terminal. For example, the first location information sent by the first access network device to the core network device includes the ephemeris information, and the first location information sent by the core network device to the terminal includes the ephemeris information and the indication information. For another example, the first location information sent by the first access network device to the core network device includes the ephemeris information and the second location information, and the first location information sent by the core network device to the terminal includes the ephemeris information and the indication information. The above description is merely illustrative, which is not limited in the embodiments of the present disclosure.

It should be noted that the steps performed by the terminal in the embodiments of the present disclosure may individually form a new embodiment, the steps performed by the access network device may individually form a new embodiment, and the steps performed by the core network device may individually form a new embodiment.

According to the solution provided by embodiments of the present disclosure, the location of the access network device can be determined by the terminal according to the obtained first location information, and the terminal is positioned according to the determined location of the access network device. The positioning of the terminal is ensured even if the access network device is moving, and the positioning accuracy is improved.

The embodiment shown in FIG. 4 describes obtaining of the first location information by the terminal. Further, the terminal actively requests to obtain the first location information. For example, referring to FIG. 5, FIG. 5 shows a flowchart of a method for indicating the location according to an example of the present disclosure, and the method for indicating the location may, for example, be applied to the terminal device 10 and the core network device 21 as shown in FIG. 1, the method including at least some of the following contents.

Step 501: a first request is sent to the core network device by the terminal, where the first request is configured to request to obtain the first location information.

Step 502: the first request sent by the terminal is received by the core network device.

Step 503: the first location information is sent to the terminal by the core network device in response to the first request.

Step 504: the first location information sent by the core network device is received by the terminal.

In the embodiments of the present disclosure, the first location information of the access network device may be actively obtained by the terminal. The first request configured to request to obtain the first location information may be sent to the core network device by the terminal, and the first location information may be returned to the terminal according to the first request after the first request is received by the core network device.

In some embodiments, a function of the first request is to obtain the first location information. After the first request is received by the core network device, the core network device may determine that the content included in the first location information returned to the terminal by itself.

In other embodiments, a function of the first request is to specify an obtained content, i.e., to specify the content included in the first location information. After the first request is received by the core network device, the first location information is returned to the terminal by the core network device based on the content specified in the first request.

For example, if the first request indicates to obtain the ephemeris information of the access network device, and the core network device returns the ephemeris information of the access network device to the terminal, based on the first request. If the first request indicates to obtain the second location information of the access network device, and the core network device returns the second location information of the access network device to the terminal.

In some embodiments, time information is also included in the first request, and the time information indicates that it is necessary to obtain first location information corresponding to time of the time information.

It should be noted that in the embodiments of the present disclosure, a long term evolution positioning protocol (LPP) message is configured for transmitting data between the terminal and the core network device. That is, the data transmitted between the terminal and the core network device is carried in the LPP message to be transmitted.

For example, data transmitted in steps 501 to 504 in the present disclosure are all sent via the LPP message.

Alternatively, the first location information is sent to the terminal by the core network device via the LPP message (LPP provide assistance information), and the first location information sent by the core network device may also be received by the terminal via the LPP provide assistance information.

For example, if the core network device is the LMF network element, the first location information is sent to the terminal by the LMF network element via the LPP provide assistance information, and it can be determined that the first location information is received after the LPP provide assistance information sent by the LMF network element is received by the terminal.

According to the solution provided in the embodiments of the present disclosure, the first location information of the core network device is obtained by the terminal through sending a request to the core network device, such that the terminal is positioned according to the first location information. The positioning of the terminal is ensured even if the access network device is moving, and the positioning accuracy is improved.

It should be noted that the embodiment of the present disclosure is described by taking the condition that the first location information is obtained by the terminal via the request as an example. In another embodiment, a solution in which the first location information is directly provided for the terminal by the core network device is also provided.

The first location information is sent to the terminal by the core network device. In the embodiments of the present disclosure, the first location information can be obtained by the core network device. After the first location information is obtained, the first location information may be sent to the terminal by the core network device, such that the first location information is received by the terminal.

In some embodiments, the first location information is sent to the terminal by the core network device via the LPP message (the LPP provide assistance information). For the terminal, the first location information is received by the terminal through receiving the LPP information (the LPP provide assistance information).

For example, if the core network device is the LMF network element, the first location information is sent to the terminal by the LMF network element via the LPP provide assistance information. For the terminal, the first location information is received by the terminal through receiving the LPP provide assistance information sent by the LMF network element.

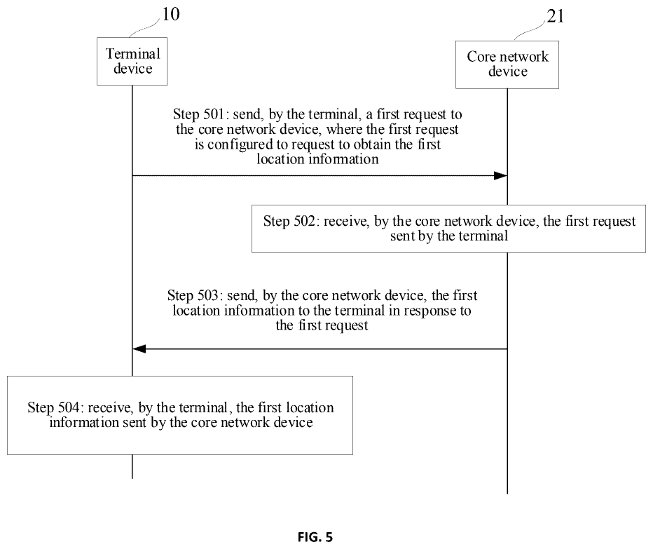

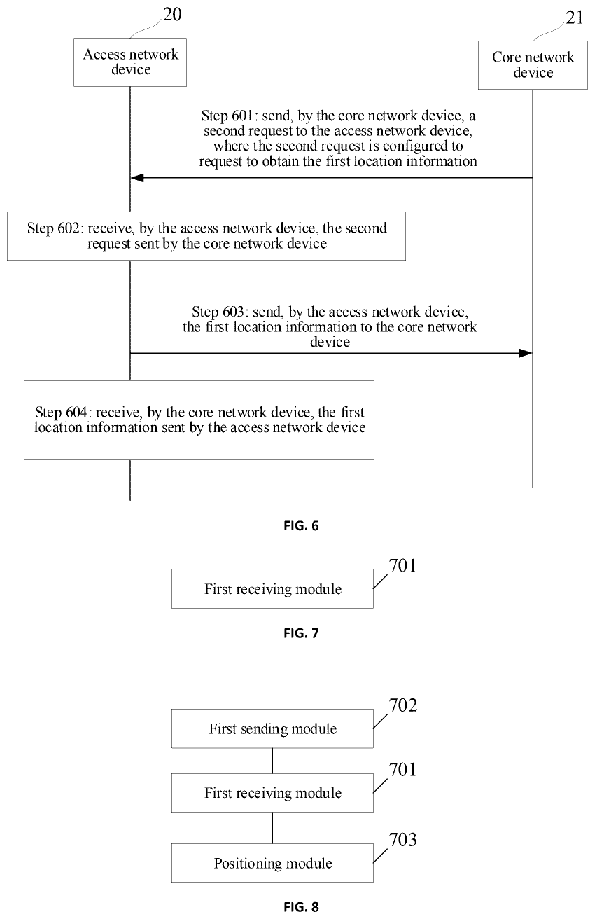

The embodiment shown in FIG. 4 describes that the first location information may be obtained by the core network device. Further, the core network device also requests the access network device to send the first location information. For example, referring to FIG. 6, FIG. 6 shows a flowchart of a method for indicating the location according to an example of the present disclosure, and the method for indicating the location may, for example, be applied to the access network device 20 and the core network device 21 as shown in FIG. 1, the method including at least some of the following contents.

Step 601: a second request is sent to the access network device by the core network device, where the second request is configured to request to obtain the first location information.

Step 602: the second request sent by the core network device is received by the access network device.

Step 603: the first location information is sent to the core network device by the access network device.

Step 604: the first location information sent by the access network device is received by the core network device.

In the embodiment of the present disclosure, if the core network device needs to obtain the first location information of the access network device, and the core network device needs to send the second request to the access network device. The second request indicates that the first location information needs to be obtained, so that it can be determined that the first location information needs to be sent after the second request is received by the access network device. The first location information is sent to the core network device by the access network device in response to the second request. The first location information sent by the access network device is received by the core network device.

In some embodiments, a function of the second request is to obtain the first location information. After the second request is received by the access network device, and the access network determines that the content included in the first location information returned to the terminal by itself.

In other embodiments, a function of the second request is to specify an obtained content, i.e., to specify the content included in the first location information. After the second request is received by the access network device, the first location information is returned to the core network device by the access network device based on the content specified in the second request.

For example, if the second request indicates to obtain the ephemeris information of the access network device, the ephemeris information of the access network device is returned to the core network device by the access network device based on the second request. If the second request indicates to obtain the second location information of the access network device, the second location information of the access network device is returned to the core network device by the access network device.

In some embodiments, time information is also included in the second request, and the time information indicates that it is necessary to obtain first location information corresponding to time of the time information.

It should be noted that in the embodiment of the present disclosure, a new radio positioning protocol a (NRPPa) message is configured for transmitting data between the access network device and the core network device. That is, the data transmitted between the access network device and the core network device is carried in the NRPPa message to be transmitted.

For example, data transmitted in steps 601 to 604 in the present disclosure are all sent via the NRPPa message.

Alternatively, the first location information is requested from the access network device by the core network device via the NRPPa message (TRP INFORMATION REQUEST), and the first location information is returned to the core network device by the access network device via the NRPPa message (TRP INFORMATION RESPONSE), based on the TRP INFORMATION REQUEST sent by the core network device.

For example, when the core network device is the LMF network element and the access network device is the TRP or the gNB. In the embodiment of the present disclosure, the TRP INFORMATION REQUEST is sent to the TRP or the gNB by the LMF network element, to request to obtain the first location information. After the TRP INFORMATION REQUEST sent by the LMF network element is received by the TRP or the gNB, the TRP INFORMATION RESPONSE is sent to the LMF network element to inform the first location information.

According to the solution provided in the embodiments of the present disclosure, the first location information of the access network device is obtained by the core network device through sending the request to the access network device, such that the first location information is returned to the terminal, and the terminal is positioned according to the first location information. The positioning of the terminal is ensured even if the access network device is moving, and the positioning accuracy is improved.

It should be noted that the embodiment of the present disclosure is described by taking the condition that the first location information is obtained by the core network device via the request as an example. In another embodiment, a solution in which the first location information is directly provided for the core network device by the access network device is also provided.

The first location information is sent to the core network device by the access network device. In the embodiment of the present disclosure, the access network device can obtain its corresponding first location information. The access network device can also actively provide its first location information to the core network device, such that the first location information is received by the core network device.

In some embodiments, the first location information is sent to the core network device by the access network device via the NRPPa message (TRP INFORMATION RESPONSE). Whereas for the core network device, the first location information sent by the access network device is received by the core network device through receiving the NRPPa message (TRP INFORMATION RESPONSE).

For example, if the core network device is the LMF network element, the first location information is sent to the LMF network element by the access network device via the TRP INFORMATION RESPONSE. Whereas for the LMF network element, the first location information is received by the LMF network element through receiving the TRP INFORMATION RESPONSE sent by the access network device.

The embodiment shown in FIG. 4 describes that the first location information may be obtained by the terminal. Further, the terminal also be positioned based on the first location information. Specifically, in the embodiment of the present disclosure, the location of the access network device indicated in the first location information is determined by the terminal, and then the terminal is positioned based on the location of the access network device indicated in the first location information.

In some embodiments, the terminal may be positioned by using positioning techniques such as down link time difference of arrival (DL-TDOA) and down link angle-of-departure (DL-AOD).

It should be noted that the embodiment of the present disclosure is described by taking the condition that the terminal is positioned as an example. In another embodiment, the location of the access network device may also be determined by the terminal based on the first location information.

In the embodiment of the present disclosure, if only the indication information is included in the first location information obtained by the terminal, no other information is included, and the location of the access network device can be determined by the terminal in any one of the following ways.

First way: the location of the access network device is determined based on the ephemeris information, where the location of the access network device is determined by the location information of the access network device at different moments as determined by the ephemeris information.

In the embodiment of the present disclosure, only the indication information is included in the first location information, and the indication information indicates that the location of the access network device is determined based on the ephemeris information.

Alternatively, the ephemeris information is configured to indicate a trajectory of the access network device during the operation, so location information of the access network device during operation at different moments can be determined based on the ephemeris information, and the location of the access network device can be determined, based on the location information of the access network device during operation at different moments.

In some embodiments, the ephemeris information is information broadcast by the access network device, and the ephemeris information broadcast by the access network device is received by the terminal. Or, the ephemeris information of the access network device may also be obtained by the terminal in other ways, which is not limited in the embodiments of the present disclosure.

In some embodiments, if the first location information includes the ephemeris information, the location of the access network device may be determined by the terminal based on the ephemeris information by default.

Alternatively, the location of the access network device is determined by the terminal based on the ephemeris information by default, in a case where it is determined that the second location information is not included in the first location information.

Second way: the location of the access network device is determined based on the second location information.

In the embodiment of the present disclosure, only the indication information is included in the first location information, and the indication information indicates that the location of the access network device is determined based on the second location information.

The second location information is configured to indicate the location of the access network device at different moments, so the location of the access network device may be directly determined by the terminal based on the second location information.

In some embodiments, the second location information is information broadcast by the access network device, and the second location information broadcast by the access network device is received by the terminal. Or, the second location information of the access network device may also be obtained by the terminal in other ways, which is not limited in the embodiments of the present disclosure.

In some embodiments, if the first location information includes the second location information, the location of the access network device may be determined by the terminal based on the second location information by default.

Alternatively, the location of the access network device is determined by the terminal based on the second location information by default, in the case where it is determined that the ephemeris information is not included in the first location information.

According to the solution provided in embodiments of the present disclosure, the terminal is positioned based on the received first location information. The positioning of the terminal is ensured even if the access network device is moving, and the positioning accuracy is improved.

It should be noted that the above embodiment is described by taking the condition that the terminal is positioned based on the first location information as an example. In another embodiment, the core network device may also be positioned based on the first location information. Then the core network device is positioned based on the first location information. In particular, in the embodiment of the present disclosure, the location of the access network device indicated in the first location information is determined by the core network device, and then positioning is performed based on the location of the access network device indicated in the first location information.

In some embodiments, the core network device may be positioned by using positioning techniques such as down link time difference of arrival (DL-TDOA), down link angle-of-departure (DL-AOD), up link time difference of arrival (UL-TDOA), and up link angle-of-departure (UL-AOA).

It should be noted that the embodiment of the present disclosure is described by taking the condition that the core network device is positioned as an example. In another embodiment, the location of the access network device may also be determined by the core network device based on the first location information.

In the embodiment of the present disclosure, if only the indication information is included in the first location information obtained by the core network device, then no other information is included, and the location of the access network device is determined by the core network device based on the ephemeris information.

In some embodiments, the ephemeris information is information broadcast by the access network device, and the ephemeris information broadcast by the access network device is received by the core network device. Or, the ephemeris information of the access network device may also be obtained by the core network device in other ways, which is not limited in the embodiments of the present disclosure.

In some embodiments, if the first location information includes the ephemeris information, the location of the access network device may be determined by the core network device based on the ephemeris information by default.

Alternatively, the location of the access network device is determined by the core network device based on the ephemeris information by default, in a case where it is determined that the second location information is not included in the first location information.

According to the solution provided in embodiments of the present disclosure, the access network device is positioned by the core network device based on the received first location information. The positioning of the access network device is ensured even if the access network device is moving, and the positioning accuracy is improved.

It should be noted that the embodiments described above may be divided into new embodiments or combined with other embodiments into new embodiments, and the present disclosure does not limit the combinations of the embodiments.

FIG. 7 shows a block diagram of a device for indicating the location according to an example of the present disclosure. Referring to FIG. 7, the device includes:

a first receiving module 701, configured to receive first location information sent by a core network device, where the first location information is configured for position the terminal and includes at least one of ephemeris information, indication information, or second location information of an access network device; the second location information is location information of the access network device at different moments; and the indication information is configured to indicate the terminal to determine a location of the access network device based on the ephemeris information or the second location information.

In some embodiments, the access network device includes a satellite, and the ephemeris information includes at least one of:
orbit information of the satellite; or
position velocity time (PVT) information of the satellite.

In some embodiments, referring to FIG. 8, the device further includes:
a first sending module 702, configured to send a first request to the core network device, where the first request is configured to request to obtain the first location information, and the core network device is configured to send the first location information in response to the first request.

In some embodiments, a long term evolution positioning protocol (LPP) message is configured for transmitting data between the core network device and the terminal.

In some embodiments, referring to FIG. 8, the device further includes:
a positioning module 703, configured to position the terminal based on the first location information.

In some embodiments, the first location information includes only the indication information, and referring to FIG. 8, the device further includes:
a positioning module 703, configured to determine the location of the access network device based on the ephemeris information, where the location of the access network device is determined by location information of the access network device at different moments as determined by the ephemeris information; or,
determine the location of the access network device based on the second location information.

It should be noted that the device provided in the above embodiment, when implementing its functions, is only illustrated by the division of the above functional modules. In practical applications, the above functions may be completed by different functional modules as needed, i.e., the internal structure of the device is divided into different functional modules to complete all or part of the functions described above. In addition, the device embodiment provided in the above embodiment belongs to the same concept as the method embodiment, and a specific implementation process is detailed in the method embodiment, which will not be described in detail herein.

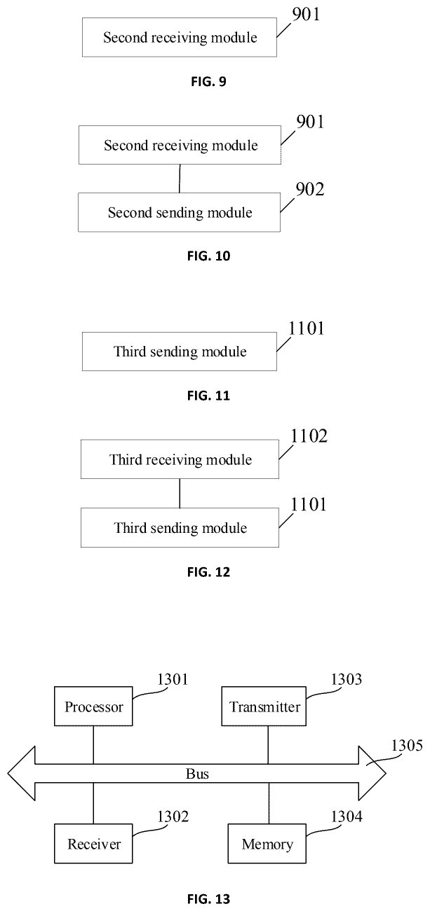

FIG. 9 shows a block diagram of a device for indicating the location according to an example of the present disclosure. Referring to FIG. 9, the device includes:
a second receiving module 901, configured to receive first location information sent by an access network device, where the first location information includes at least one of ephemeris information, indication information, or second location information of the access network device, the second location information is location information of the access network device at different moments, and the indication information is configured to indicate a terminal to determine the location of the access network device based on the ephemeris information or the second location information.

In some embodiments, the access network device includes a satellite, and the ephemeris information includes at least one of:
orbit information of the satellite; or
position velocity time (PVT) information of the satellite.

In some embodiments, the second receiving module 901 is further configured to receive a first request sent by the terminal, where the first request is configured to request to obtain the first location information.

In some embodiments, referring to FIG. 10, the device further includes:
a second sending module 902, configured to send the first location information to the terminal in response to the first request.

In some embodiments, the device further includes:
a second sending module 902, configured to send a second request to the access network device, where the second request is configured to request to obtain the first location information.

In some embodiments, a new radio positioning protocol a (NRPPa) message is configured for transmitting data between the core network device and the access network device.

It should be noted that the device provided in the above embodiment, when implementing its functions, is only illustrated by the division of the above functional modules. In practical applications, the above functions may be completed by different functional modules as needed, i.e., the internal structure of the device is divided into different functional modules to complete all or part of the functions described above. In addition, the device embodiment provided in the above embodiment belongs to the same concept as the method embodiment, and a specific implementation process is detailed in the method embodiment, which will not be described in detail herein.

FIG. 11 shows a block diagram of a device for indicating the location according to an example of the present disclosure. Referring to FIG. 11, the device includes:

a third sending module 1101, configured to send first location information to a core network device, where the first location information includes at least one of ephemeris information, indication information, or second location information of the access network device, the second location information is location information of the access network device at different moments, and the indication information is configured to indicate a terminal to determine a location of the access network device based on the ephemeris information or the second location information.

In some embodiments, the access network device includes a satellite, and the ephemeris information includes at least one of:
orbit information of the satellite; or
position velocity time (PVT) information of the satellite.

In some embodiments, referring to FIG. 12, the device further includes:
a third receiving module 1102, configured to receive a second request sent by the core network device, where the second request is configured to request to obtain the first location information.

In some embodiments, a new radio positioning protocol a (NRPPa) message is configured for transmitting data between the core network device and the access network device.

It should be noted that the device provided in the above embodiment, when implementing its functions, is only illustrated by the division of the above functional modules. In practical applications, the above functions may be completed by different functional modules as needed, i.e., the internal structure of the device is divided into different functional modules to complete all or part of the functions described above. In addition, the device embodiment provided in the above embodiment belongs to the same concept as the method embodiment, and a specific implementation process is detailed in the method embodiment, which will not be described in detail herein.

FIG. 13 shows a schematic structural diagram of a communication device according to an example of the present disclosure, the communication device including one or more processors 1301, a receiver 1302, a transmitter 1303, a memory 1304, and a bus 1305.

The one or more processors 1301 includes one or more processing cores and executes various functional applications and information processing by running software programs and modules.

The receiver 1302 and the transmitter 1303 may be implemented as one communication component which may be a communication chip.

The memory 1304 is connected to the one or more processors 1301 via the bus 1305.

The memory 1304 may be configured to store at least one program code, and the one or more processors 1301 is configured to execute the at least one program code to collectively implement the steps in the above method embodiments.

Further, the communication device may be a terminal or an access network device. The memory 1304 may be implemented by any type of volatile or non-volatile storage devices, or a combination of them, the volatile or non-volatile storage device including but not limited to: a magnetic disk or an optical disk, an electrically erasable programmable read-only memory (EEPROM), an erasable programmable read-only memory (EPROM), a static random access memory (SRAM), a read-only memory (ROM), a magnetic memory, a flash memory and a programmable read-only memory (PROM).

In an example, a non-transitory computer-readable storage medium is also provided, where executable program codes are stored in the non-transitory computer-readable storage medium, and the executable program codes, when loaded and executed by one or more processors, implements the method for indicating the location performed by the communication device provided in the above method embodiments.

In an example, a chip is provided. The chip includes at least one of a programmable logic circuit or program instructions, and the chip, when run on a terminal or an access network device, is configured to implement the method for indicating the location as provided in the method embodiments.

In an example, a communication system is provided. The communication system includes a terminal, an access network device and a core network device, where the terminal is configured to implement the method for indicating the location, the access network device is configured to implement the method for indicating the location, and the core network device is configured to implement the method for indicating the location.

In an example, a computer program product is provided. The computer program product, when collectively executed by one or more processors of a terminal or an access network device, is configured to implement the method for indicating the location provided in the above method embodiments.

As used herein, the term processor may refer to one processor that performs the defined functions or a plurality of processors that collectively perform defined functions, such that the execution of the individual defined functions may be divided amongst such processors.

It will be appreciated by those of ordinary skill in the art that all or part of the steps for implementing the embodiments described above may be performed by hardware or may be performed by instructing related hardware through a program, and the program may be stored in a non-transitory computer readable storage medium which may be a read-only memory, a magnetic disk or an optical disk.

The above are only optional embodiments of the present disclosure, and are not intended to limit the present disclosure, and any modifications, equivalent substitutions, improvements, and the like made within the spirit and principle of the present disclosure should be included in the protection scope of the present disclosure.

1. A method for indicating a location, performed by a terminal, the method comprising:
receiving first location information sent by a core network device, wherein
the first location information is configured for positioning the terminal and comprises at least one of ephemeris information, indication information, or second location information of an access network device;
the second location information is location information of the access network device at different moments; and
the indication information is configured to indicate the terminal to determine a location of the access network device based on the ephemeris information or the second location information.

2. The method according to claim 1, wherein the access network device comprises a satellite, and the ephemeris information comprises at least one of the following:
orbit information of the satellite; or
position velocity time (PVT) information of the satellite.

3. The method according to claim 1, further comprising:
sending a first request to the core network device, wherein the first request is configured to request to obtain the first location information, and the core network device is configured to send the first location information in response to the first request.

4. The method according to claim 1, wherein a long term evolution positioning protocol (LPP) message is configured for transmitting data between the core network device and the terminal.

5. The method according to claim 1, further comprising:
positioning the terminal based on the first location information.

6. The method according to claim 1, wherein the first location information comprises only the indication information, and the method further comprises:
determining the location of the access network device based on the ephemeris information, wherein the location of the access network device is determined by the location information of the access network device at the different moments as determined by the ephemeris information; or,
determining the location of the access network device based on the second location information.

7. A method for indicating a location, performed by a core network device, the method comprising:
receiving first location information sent by an access network device, wherein
the first location information comprises at least one of ephemeris information, indication information, or second location information of the access network device;
the second location information is location information of the access network device at different moments; and
the indication information is configured to indicate a terminal to determine a location of the access network device based on the ephemeris information or the second location information.

8. The method according to claim 7, wherein the access network device comprises a satellite, and the ephemeris information comprises at least one of the following:
orbit information of the satellite; or
position velocity time (PVT) information of the satellite.

9. The method according to claim 7, further comprising:
receiving a first request sent by the terminal, wherein the first request is configured to request to obtain the first location information.

10. The method according to claim 9, further comprising:
sending the first location information to the terminal in response to the first request.

11. The method according to claim 7, further comprising:
sending a second request to the access network device, wherein the second request is configured to request to obtain the first location information.

12. The method according to claim 11, wherein a new radio positioning protocol a (NRPPa) message is configured for transmitting data between the core network device and the access network device.

13. A method for indicating a location, performed by an access network device, the method comprising:
sending first location information to a core network device, wherein
the first location information comprises at least one of ephemeris information, indication information, or second location information of the access network device;
the second location information is location information of the access network device at different moments; and
the indication information is configured to indicate a terminal to determine a location of the access network device based on the ephemeris information or the second location information.

14. The method according to claim 13, wherein the access network device comprises a satellite, and the ephemeris information comprises at least one of the following:
orbit information of the satellite; or position velocity time (PVT) information of the satellite.

15. The method according to claim 13, further comprising:
receiving a second request sent by the core network device, wherein the second request is configured to request to obtain the first location information.

16. The method according to claim 13, wherein a new radio positioning protocol a (NRPPa) message is configured for transmitting data between the core network device and the access network device.

17-19. (canceled)

20. A terminal, comprising:
one or more processors; and
a transceiver connected to the one or more processors;
wherein the one or more processors are configured to load and execute executable instructions to collectively perform the method for indicating the location according to claim lany

21. An access network device, comprising:
one or more processors; and
a transceiver connected to the one or more processors;
wherein the one or more processors are configured to load and execute executable instructions to collectively perform the method for indicating the location according to claim 7.

22. A core network device, comprising:
one or more processors; and
a transceiver connected to the one or more processors;
wherein the one or more processors are configured to load and execute executable instructions to collectively perform the method for indicating the location according to claim 13.

23. (canceled)

24. A non-transitory computer-readable storage medium, storing executable program codes, the executable program codes, when loaded and executed by a processor, implement the method for indicating the location according to claim 1.
